(19) United States
(12) Patent Application Publication
(10) Pub. No.: US 2014/0238937 A1
(43) Pub. Date: Aug. 28, 2014

(54) SYSTEMS AND METHODS FOR IMPROVING FLUX IN OSMOTICALLY DRIVEN MEMBRANE SYSTEMS

(71) Applicant: Robert L. McGinnis, Conventry, CT (US)

(72) Inventor: Robert L. McGinnis, Conventry, CT (US)

(73) Assignee: OASYS WATER, INC., Boston, MA (US)

(21) Appl. No.: 14/236,552

(22) PCT Filed: Jul. 31, 2012
(86) PCT No.: PCT/US2012/049042

§ 371 Date: Apr. 25, 2014

Related U.S. Application Data
(60) Provisional application No. 61/514,661, filed on Aug. 3, 2011.

(51) Int. Cl. B01D 65/08

(52) U.S. Cl. CPC B01D 65/08
USPC 210/636; 210/209

(57) ABSTRACT

The invention relates to improving flux in osmotically driven membrane systems by promoting and controlling the growth of biofilms on a surface of the membrane.

### CROSS-REFERENCE TO RELATED APPLICATIONS

This application claims the benefit of and priority to U.S. Provisional Patent Application Ser. No. 61/514,661, filed Aug. 3, 2011; the entire disclosure of which is hereby incorporated by reference herein in its entirety.

### FIELD OF THE INVENTION

The invention generally relates to improving flux in osmotically driven membrane systems, and more particularly to promoting and controlling the growth of a biofilm on a surface of the membrane to prevent membrane fouling.

### BACKGROUND

Traditionally, membrane surfaces have been treated or otherwise manufactured to resist the formation of a biofilm thereon. See, for example, U.S. Patent Publication No. 2007/0251883, the disclosure of which is hereby incorporated by reference herein in its entirety. The formation of biofilms on membranes has been considered a form of fouling and detrimental to the operation of a membrane system by, for example, reducing the flux of the system.

### SUMMARY

Generally, promoting the growth of a select type of biofilm on a membrane surface (e.g., the feed and/or permeate side) can provide a beneficial service to the engineered system in which the membrane is used. These beneficial services can include oxidation of feed constituents that might otherwise pass through the membrane surface (e.g., small uncharged organics), the creation of a smooth, uniform surface on the membrane surface, which can prevent fouling, and the reduction of minerals that would otherwise scale on the membrane surface. In one case, preventing or at least reducing fouling on the membrane surface can assist in maintaining a higher and/or more constant flux level. Generally, fouling is used herein to refer to various types of membrane contamination that may reduce flux or otherwise detrimentally effect the membrane and include: crystalline fouling (mineral scaling, or deposit of minerals due to an excess in the solution product), organic fouling (deposition of dissolved humic acid, oil, grease, etc.), particle and colloid fouling (deposition of clay, silt, particulate humic substances, debris and silica), and microbial fouling (biofouling, adhesion and accumulation of microorganisms, and the formation of biofilms). In some embodiments, the formation of a select type of biofilm can inhibit or prevent the formation of a detrimental biofilm.

In one aspect, the invention relates to a method of promoting or stabilizing the flux rate in an osmotically driven membrane system. The method includes the steps of providing a forward osmosis membrane having a feed side and a permeate side, introducing a feed solution to the feed side of the forward osmosis membrane, introducing a draw solution to the permeate side of the forward osmosis membrane, and promoting the growth of a select biofilm (e.g., a desired biofilm as opposed to an undesirable biofilm that may have the tendency to otherwise form on the membrane, but imparts no beneficial effect) on at least one of the feed side or the permeate side of the forward osmosis membrane. For example, the feed side of the membrane can naturally or be modified to form a support structure for the particular biofilm. The growth of one or more types of biofilms can be promoted to suit a particular application, for example, to prevent scaling. In one embodiment, the draw solution includes at least one select nutrient to assist in the formation of the biofilm. The solutions used can be aqueous or non-aqueous to suit a particular application.

In various embodiments of the foregoing invention, the step of promoting the growth of a biofilm includes introducing at least one nutrient to the feed solution to preferentially react with one or more microorganisms that may be present in the feed solution or may be added to the feed or draw solution. In one embodiment, the at least one nutrient is introduced to the feed solution via reverse transport through the forward osmosis membrane from the draw solution. Alternatively or additionally, the at least one nutrient can be directly introduced to the source of the feed solution or the draw solution. The at least one nutrient can be introduced, for example, manually through a receptacle or other opening in a chamber holding the feed or draw solution or a housing containing the membrane. In one embodiment, the nutrient and/or microorganism can be added via a hopper with a metering device (e.g., a valve) that can introduce the at least one nutrient and/or microorganism in a controlled manner. The at least one nutrient/microorganism can be introduced in, for example, liquid or powder form. The means for introducing the at least one nutrient/microorganism can also include a stirrer or other types of equipment for mixing the nutrient/microorganism within the selected solution for relatively even dispersal. The means for introducing the at least one nutrient/microorganism can also include a control system with associated sensors and switches that can monitor a state or characteristic of any of the draw solution, the feed solution, and the membrane (e.g., flux rate or material) and control the introduction of the at least one nutrient or other substance to promote and/or control the growth of the biofilm based, for example, on the measured state or characteristic.

Furthermore, the step of promoting the growth of a biofilm can also include controlling the concentration of the at least one nutrient/microorganism in, for example, the draw or feed solution. The at least one nutrient can be essentially any organic or non-organic material including, for example, petroleum based substances, amino acids, carbon, oxygen, vitamins, sugars, nitrates, phosphates, etc. The microorganism can be selected from the group including, for example, bacteria, protein, archea, protozoa, fungi, and algae, or combinations thereof. The step of promoting the growth of a biofilm can also include the step of introducing (e.g., injecting) carbon dioxide into the feed solution. Additionally, heat can also be introduced into the feed solution to promote the growth of the biofilm. The method can also include the step of controlling the growth of the biofilm by, for example, periodic or continuous air scouring, or higher velocity flow to reduce the film thickness. The quantity and/or quality of the nutrients can also impact the growth of the biofilm. In addition, various types of biocides (e.g., antimicrobials, oxidizing and non-oxidizing microbicides) can be introduced to the system to control the growth of the biofilm. The step of promoting the growth of a biofilm can include growing an open matrix biofilm.

In another aspect, the invention relates to a system for promoting flux in an osmotically driven membrane system. The system includes a forward osmosis membrane having a permeate side and a feed side, a source of a feed solution in fluid communication with the feed side of the forward osmosis membrane, a source of a draw solution in fluid communication with the permeate side of the forward osmosis membrane, and means for introducing at least one select nutrient to the feed and/or permeate side of the forward osmosis membrane to promote the growth of a select biofilm on at least a portion of a surface (e.g., the feed side) of the forward osmosis membrane. In some embodiments, the means for introducing the at least one nutrient can include means for introducing at least one microorganism in addition to or instead of the at least one nutrient.

In various embodiments, the draw solution includes ammonia and carbon dioxide in a molar ratio of at least 1:1. The at least one nutrient can comprise ammonia ions. The at least one microorganism can be selected from the group including bacteria, protein, archea, protozoa, fungi, and algae, or combinations thereof. The means for introducing the at least one nutrient and/or microorganism can include an apparatus in communication with the source of the feed solution and/or the source of the draw solution. In the case of introducing the at least one nutrient to the source of draw solution, the at least one nutrient travels to the feed side of the forward osmosis membrane via reverse transport therethrough. The apparatus can be in fluid communication with the source of feed or draw solution in the case of introducing the at least one nutrient in liquid form. The system can also include means for introducing carbon dioxide to the feed side of the forward osmosis membrane, for example, via injection into the feed solution.

In various embodiments, the at least one nutrient and/or microorganism can be introduced, for example, manually through a receptacle or other opening in a chamber holding the feed or draw solution or a housing containing the membrane, or a hopper with a metering device or other known dispensing mechanisms that can introduce the at least one nutrient and/or microorganism in a controlled manner. The at least one nutrient/microorganism can be introduced in, for example, liquid or powder form. The means for introducing the at least one nutrient can also include a stirrer or other types of equipment for mixing the nutrient/microorganism within the selected solution for relatively even dispersal. The means for introducing the at least one nutrient/microorganism can also include a control system that can monitor a state or characteristic of any of the draw solution, the feed solution, and the membrane (e.g., flux rate or material) and control the introduction of the at least one nutrient or other substance to promote and/or control the growth of the biofilm.

In some embodiments, the nutrient sources can include organic matter present in the source of the feed solution, introduced to the feed solution for this specific purpose (e.g., methanol), or introduced into the draw solution (or be a constituent thereof), where it would diffuse through the membrane to the feed side surface and a biofilm could oxidize them (e.g., ammonia and ammonia ions). In one example, a biofilm can be generated to prevent scaling where minerals that form on the biofilm would be reduced by the biofilm and resolubilized. The process would be fueled by electrons pulled from the ammonia from the draw solution that diffused through the membrane as “reverse salt flux.” In one embodiment, the nutrient(s) is selected to promote the formation of a biofilm from bacteria that may typically be found in brines that oxidize iron and sulfur compounds as their energy source and produce leaching reagents for the solubilization of metals (e.g., chemolithoautotrophc bacteria, such as iron-oxidizing bacteria or nitrifying bacteria). In this case, the biochemical reaction on the surface of the membrane may prevent irreversible scaling. Alternatively or additionally, a chemical ligand or other anti-scalant type substance can be reverse fluxed through the membrane to release or prevent certain fouling layers from adhering to the feed side of the membrane.

These and other objects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention and are not intended as a definition of the limits of the invention. For purposes of clarity, not every component may be labeled in every drawing. In the following description, various embodiments of the present invention are described with reference to the following drawings, in which:

FIG. 1 is a schematic representation of a system in accordance with one or more embodiments of the invention;

FIG. 2 is flow chart illustrating the various steps of a method in accordance with one or more embodiments of the invention; and

FIG. 2A is a flow chart illustrating the various sub-steps of one of the steps of the method of FIG. 2.

### DETAILED DESCRIPTION

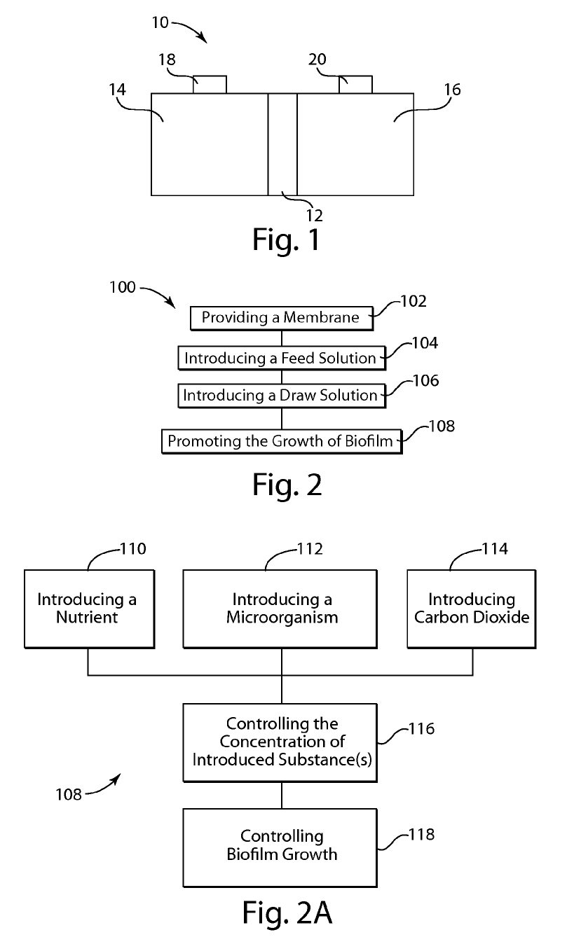

FIG. 1 depicts one possible system for improving flux in an osmotically driven membrane system 10. The system 10 includes a membrane system 12 that can include one or more forward osmosis membranes or membrane modules. Various membrane systems and their associated components are disclosed in U.S. Pat. Nos. 6,391,205 and 7,560,029; and PCT Publication Nos. WO2009/155596, WO2011/053794, and WO2011/059751, the disclosures of which are hereby incorporated by reference herein in their entireties. Various membranes that can be used in the disclosed systems are described in U.S. Patent Publication Nos. 2011/0036774 and 2011/0073540, the disclosures of which are hereby incorporated by reference herein in their entireties. Standard membranes can be used as well.

A source of a first solution 14, also referred to as a feed solution, is in fluid communication with the membrane system 12. The feed solution may normally contain a variety of microorganisms that can be used to form a biofilm or specific substances (e.g., bacteria) can be added to the feed solution to assist in the growth of a select biofilm. The system 10 also includes a source of a second solution 16, also referred to as a draw solution, that is also in fluid communication with the membrane system 12. The draw solution can include one or more nutrients or other substances (e.g., microorganisms) that can be added to the draw solution. The nutrient(s) can be reverse transported through the membrane system 12 to the feed side of the membrane, where they will preferentially react with select microorganisms and promote the growth of a select biofilm on at least a portion of the surface of the feed side of the membrane. In some embodiments, the nutrient or other substance can be selected to impede the formation of certain types of fouling layers, either instead of or in addition to the formation of the beneficial biofilm.

Typically, the membrane system 12 includes one or more membranes immersed within a chamber or some type of housing. The housing can include means for introducing the nutrients to the permeate side and/or the feed side of the membrane. The sources of feed and draw solutions 14, 16 can be chambers disposed adjacent a membrane chamber or be part of the membrane system assembly. Alternatively or additionally, the sources of feed and draw solutions 14, 16 can be located remotely and the solutions transported to the membrane system 12 via, for example, pumps, valving, and any necessary plumbing. The system 10 can further include means 18 for introducing either microorganisms or nutrients to the feed solution and/or means 20 for introducing microorganisms and/or nutrients to the draw solution.

The nutrient(s) is selected to react with one or more particular microorganisms in the feed solution, so that when the feed solution is introduced to the feed side of the membrane, the microorganisms will begin to attach themselves to the surface of the feed side of the membrane, thereby starting the formation of the biofilm. In some embodiments, select microorganisms are introduced to the feed solution to promote the growth of a select biofilm. The microorganisms will form a matrix on the surface of the membrane that resists fouling of the membrane (e.g., by repelling or consuming other substances that may be present in the feed solution), thereby maintaining a more consistent flux through the membrane system 12. Generally, the formation of the biofilm may slightly reduce the initial flux rate of the membrane system, but because the biofilm prevents or at least reduces fouling of the membrane, the flux level does not drop off as precipitously as would occur with typical membrane fouling.

FIG. 2 depicts the various steps that may be carried out in order to perform the method 100 of promoting flux in an osmotically driven membrane system. The method 100 includes the initial step of providing a forward osmosis membrane 102, where the membrane has a feed side and a permeate side, and then in any order, introducing a feed solution to the feed side of the forward osmosis membrane 104 and introducing a draw solution to the permeate side of the forward osmosis membrane 106. Finally, the method 100 includes the step of promoting the growth of a biofilm on the feed side of the forward osmosis membrane 108. The method may include additional steps related to the promoting the growth of the biofilm as shown in FIG. 2A.

As shown in FIG. 2A, such additional steps include one or more of introducing at least one nutrient 110, introducing at least one microorganism 112, and/or introducing carbon dioxide 114 to the feed solution. The step of promoting the growth of the biofilm 108 can also include controlling the rate of introduction and/or concentration levels of the aforementioned substances 116. The rate of introduction and concentration levels can be controlled to, for example, control the rate of growth of the biofilm or the structure thereof or maintain the biofilm at an optimal level. Additionally, the method can include the step of controlling the growth of the biofilm 118, which can include introducing additional substances to the feed and/or draw solutions to influence the formation of the biofilm. For example, a substance can be added to the feed solution to impede the growth of the biofilm beyond an optimal level.

The various systems described herein may be interconnected by via conventional plumbing techniques and can include any number and combination of components, such as pumps, valves, sensors, gauges, etc., to monitor and control the operation of the various systems and processes described herein. The various components can be used in conjunction with a controller or control system to, for example, adjust or regulate at least one operating parameter of a component of the system, such as, but not limited to, actuating valves and pumps, as well as adjusting a property or characteristic of one or more fluid flow streams.

The control system may be in electronic communication with at least one sensor configured to detect at least one operational parameter of the system, such as a concentration, flow rate, pH level, pressure, or temperature, and may be generally configured to generate a control signal to adjust one or more operational parameters in response to a signal generated by a sensor. The control system typically includes an algorithm that facilitates generation of at least one output signal that is typically based on one or more of any of the representation and a target or desired value such as a set point. In accordance with one or more particular aspects, the control system can be configured to receive a representation of any measured property of any stream or component, and generate a control, drive or output signal to any of the system components, to reduce any deviation of the measured property from a target value.

Those skilled in the art should appreciate that the parameters and configurations described herein are exemplary and that actual parameters and/or configurations will depend on the specific application in which the systems and methods of the invention are used. Those skilled in the art should also recognize or be able to ascertain, using no more than routine experimentation, equivalents to the specific embodiments of the invention. It is, therefore, to be understood that the embodiments described herein are presented by way of example only and that, within the scope of the appended claims and equivalents thereto; the invention may be practiced otherwise than as specifically described.

What is claimed is:

1. A method of promoting flux in an osmotically driven membrane system, the method comprising the steps of:
providing a forward osmosis membrane having a feed side and a permeate side;
introducing a feed solution to the feed side of the forward osmosis membrane;
introducing a draw solution to the permeate side of the forward osmosis membrane; and
promoting the growth of a biofilm on a surface of the forward osmosis membrane.

2. The method of claim 1, wherein the step of promoting the growth of a biofilm comprises introducing at least one nutrient to the feed solution to preferentially react with one or more microorganisms present therein.

3. The method of claim 2, wherein the draw solution comprises the at least one nutrient, which is introduced to the feed solution via reverse transport through the forward osmosis membrane from the draw solution.

4. The method of claim 2, wherein the at least one nutrient is directly introduced to the feed solution.

5. The method of claim 2, wherein the step of promoting the growth of a biofilm comprises controlling the concentration of the at least one nutrient.

6. The method of claim 2, wherein the at least one nutrient comprises an ammonia ion.

7. The method of claim 2, wherein the step of promoting the growth of a biofilm comprises introducing at least one microorganism to the feed solution.

8. The method of claim 1, wherein the step of promoting the growth of a biofilm comprises the step of introducing carbon dioxide into the feed solution.

9. The method of claim 1, further comprising the step of controlling the growth of the biofilm.

10. The method of claim 1, wherein the step of promoting the growth of a biofilm comprises growing an open matrix biofilm.

11. A system for promoting flux in an osmotically driven membrane system, the system comprising:
a forward osmosis membrane having a permeate side and a feed side;
a source of a feed solution in fluid communication with the feed side of the forward osmosis membrane;
a source of a draw solution in fluid communication with the permeate side of the forward osmosis membrane; and
means for introducing at least one nutrient to the feed side of the forward osmosis membrane to promote the growth of a biofilm on at least a portion of a surface of the forward osmosis membrane.

12. The system of claim 11, wherein the draw solution comprises ammonia and carbon dioxide in a molar ratio of at least 1:1.

13. The system of claim 11, wherein the at least one nutrient comprises an ammonia ion.

14. The system of claim 11, wherein the means for introducing at least one nutrient comprises an apparatus in communication with the source of a feed solution.

15. The system of claim 11, wherein the means for introducing the at least one nutrient comprises an apparatus in communication with the source of a draw solution, where the nutrient travels to the feed side of the forward osmosis membrane via reverse transport therethrough.

16. The system of claim 11, further comprising means for introducing carbon dioxide to the feed side of the forward osmosis membrane.
